(19) United States
(12) Patent Application Publication
(10) Pub. No.: US 2011/0256380 A1
(43) Pub. Date: Oct. 20, 2011

(54) INTER-LAYER GELATINOUS BODY SUPPORT ADHESIVE AND METHOD OF MANUFACTURING A BODY SUPPORT USING THE SAME

(76) Inventors: Kelly W. Chandler, Gate City, VA (US); Tom D. Mikkelsen, Kingsport, TN (US)

(21) Appl. No.: 13/141,794

(22) PCT Filed: Dec. 18, 2009
(86) PCT No.: PCT/US09/68812

§ 371 Date: Jun. 23, 2011

Related U.S. Application Data
(60) Provisional application No. 61/140,587, filed on Dec. 23, 2008.

(51) Int. Cl. B32B 3/26; B32B 37/12; B32B 7/12

(52) U.S. Cl. 428/316.6; 428/317.1; 156/60

(57) ABSTRACT

A body support assembly including a first layer, a second layer, at least one of the first and second layers comprises a visco-elastic foam, and a gel adhesive bonding the first layer to the second layer. A method of assembling the body support assembly including applying a gelatinous adhesive on at least one of a top surface of the first layer of foam and a bottom surface of the second layer of foam, positioning the second layer of foam on the first layer of foam, and coupling the second layer of foam to the first layer of foam with the gelatinous adhesive.

### CROSS-REFERENCE TO RELATED APPLICATIONS

Priority is hereby claimed to U.S. Provisional Patent App. No. 61/140,587, filed Dec. 23, 2008, the entire contents of which are herein incorporated by reference.

### BACKGROUND

Conventional body supports are found in a wide variety of shapes and sizes, each of which is adapted for supporting one or more body parts of a user. As used herein, the term “body support” includes without limitation any deformable element or structure adapted to support one or more parts of (or the entire body of) a human or animal in one or more positions. Examples of body supports include but are not limited to mattresses, pillows, and cushions of any type, including those for use in beds, seats, and other applications.

Body supports are often constructed entirely or partially out of foam material. For example, polyurethane foam is commonly used in many mattresses, pillows, and cushions, and can be used alone or in combination with other types of cushion materials. In many body supports, visco-elastic material is used, providing the body support with an increased ability to conform to a user and to thereby distribute the weight or other load of the user. Some visco-elastic body support materials are also temperature sensitive, thereby also enabling the body support to change firmness based at least in part upon the temperature of the body part(s) supported thereon.

Some body supports include multiple layers of foam or other material. One or more adhesives are often used to couple the layers together to inhibit shifting of one layer with respect to an adjacent layer. For example, in body supports having two or more layers of foam, adhesive can be used between the foam layers to secure the foam layers in place with respect to one another. However, these adhesives typically alter the softness or “feel” of the body support, such as in cases where the adhesive that is used cures or otherwise hardens to a significantly firmer and/or less flexible state. This is particularly the case when one or more of the layers joined together include visco-elastic foam material, which can dramatically change firmness and shape in use, and which can therefore can have reduced ability to mask a harder inter-layer adhesive material.

Although the number and types of body supports constructed with one or more layers of foam continue to increase, including one or more layers of foam comprising visco-elastic foam, the capabilities of such materials are often underutilized. In many cases, this underutilization is due to poor body support design and/or the choice of adhesive material(s) used in the body support.

Based at least in part upon the limitations of existing body supports and the high consumer demand for improved body supports in a wide variety of applications, new body supports and inter-layer adhesives for body supports are welcome additions to the art.

### SUMMARY

In some embodiments, the present invention provides a body support having a first layer of foam with a first top surface and a first bottom surface opposite the first top surface, a second layer of foam having a second top surface and a second bottom surface opposite the second top surface, and an adhesive applied to at least one of the first top surface and the second bottom surface, wherein the second bottom surface is positioned adjacent the first top surface, and is coupled to the first top surface by the adhesive, wherein at least one of the first layer and the second layer comprises visco-elastic foam, and wherein the adhesive is a gelatinous adhesive.

Some embodiments of the invention provide a body support assembly including a first layer, a second layer, at least one of the first and second layers comprises a visco-elastic foam, and a gel adhesive bonding the first layer to the second layer.

Some embodiments of the present invention provide a method of assembling a body support including applying a gelatinous adhesive on at least one of a top surface of a first layer of foam and a bottom surface of a second layer of foam, positioning the second layer of foam on the first layer of foam, and coupling the second layer of foam to the first layer of foam with the gelatinous adhesive, wherein at least one of the first and second layers of foam comprises visco-elastic foam.

Other aspects of the present invention will become apparent by consideration of the detailed description and accompanying drawings.

### BRIEF DESCRIPTION OF THE DRAWINGS

FIG. 1 is a perspective view of a body support according to an embodiment of the present invention.

FIG. 2 is an exploded view of the body support of FIG. 1.

FIG. 3 is an exploded view of a body support according to another embodiment of the present invention.

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to order or importance (e.g., “first”, “second”, and “third”) are used herein and in the appended claims for purposes of description, and are not alone intended to indicate or imply relative order or importance unless otherwise specified. The term “first” does not necessarily refer to the top most layer, rather, it refers to the first of a plurality, without indicating a particular location or position.

The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

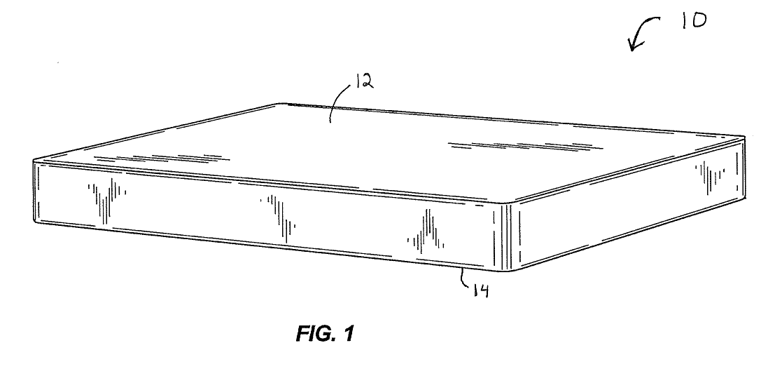

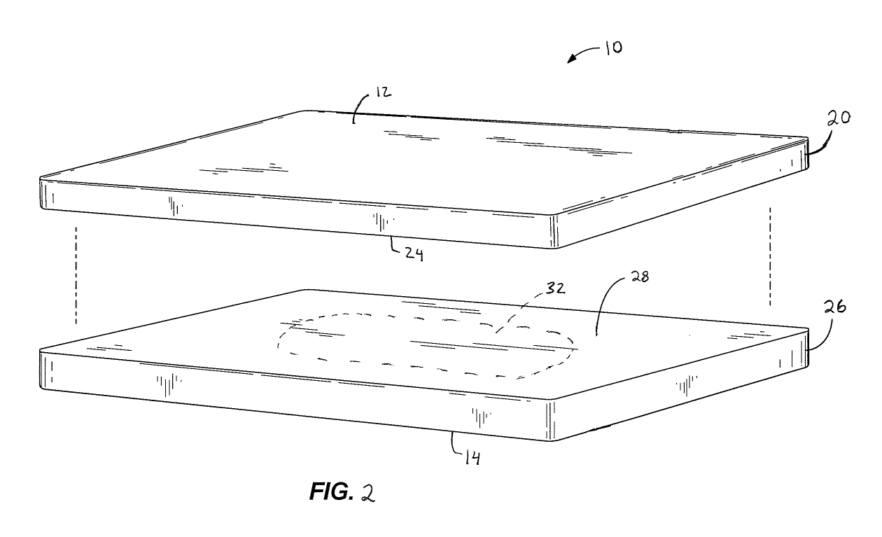

A body support 10 according to an embodiment of the present invention is illustrated in FIGS. 1 and 2. The body support 10 includes a top surface 12 positioned to support a user and a bottom surface 14 positioned to be proximate a frame, floor, or other surface to support the body support 10. The body support 10 can include one or more layers of foam, and in some embodiments can also include one or more layers of other material.

The body support 10 illustrated in FIGS. 1 and 2 is a mattress. However, in other embodiments, the body support 10 can take other forms, such as a mattress topper, overlay, or futon. It will be appreciated that the features of the body support 10 described herein are applicable to any type of body support having any size and shape. By way of example only, these features are equally applicable to head pillows, seat cushions (including the base and/or back cushions of a seat), neck pillows, leg spacer pillows, eye masks, and any other structure used to support and/or cushion any part or all of a human's or animal's body. Accordingly, as used herein and in the appended claims, the term “body support” refers to any and all of such structures (in addition to mattresses, mattress toppers, overlays, sleeper sofas, and futons). It should also be noted that each of the body supports described and/or illustrated herein is presented in a particular form, such as a mattress, mattress topper, overlay, futon, or pillow. However, absent description herein to the contrary, any or all of the features of each such body support can be applied to any other type of body support having any other shape and size, including the various types of body supports mentioned above.

With reference again to the illustrated body support 10 of FIGS. 1 and 2, the body support 10 can include one or more layers of foam in stacked relation, and can be enclosed within a cover 11 of any type, such as a woven or non-woven material, a knitted material, a material comprising cotton, wool, or other natural fiber, polyester, rayon, nylon, foam, or other synthetic material, and a material that is liquid and vapor impermeable, liquid impermeable and vapor permeable, or liquid and vapor permeable. FIG. 2 shows the body support of FIG. 1 with the cover 11 removed.

As shown in FIG. 2, the body support 10 can include a top layer 20 having an upper surface that is top surface 12 of the body support 10 and a lower surface 24 opposite the top surface 12. The body support 10 can further include a bottom layer 26 having an upper surface 28 and a lower surface that is a bottom surface 14 of the body support 10 opposite the upper surface 28. The top layer 20 and the bottom layer 26 can comprise a foam material, such as a polyurethane foam, latex foam, reticulated foam, non-reticulated foam, any expanded polymer (e.g., expanded ethylene vinyl acetate, polypropylene, polystyrene, or polyethylene), and the like. In some embodiments, either or both layers 20, 26 comprise visco-elastic foam. The visco-elastic foam can, in some embodiments, be temperature-sensitive to the body heat of a user, thereby changing in firmness in response to receiving the body heat of a user upon the foam.

Also in some embodiments, either or both layers 20, 26 can comprise reticulated foam. Reticulated foam (visco-elastic or otherwise) is a cellular foam structure in which the cells of the foam are essentially skeletal. In other words, the cells of the reticulated foam are each defined by a plurality of apertured windows surrounded by cell struts. The cell windows of reticulated foam can be entirely gone (leaving only the cell struts) or substantially gone. In some embodiments, the foam is considered “reticulated” if at least 50% of the windows of the cells are missing (i.e., windows having apertures therethrough, or windows that are completely missing and therefore leaving only the cell struts). Such structures can be created by destruction or other removal of cell window material, or preventing the complete formation of cell windows during the manufacturing process of the foam.

With continued reference to the embodiment of FIGS. 1 and 2, the top and bottom layers 20, 26 are secured to one another by adhesive or cohesive bonding material. A quantity of adhesive 32 can be applied to one or both of the upper surface 28 of the bottom layer 26 and the lower surface 24 of the top layer 20. In the illustrated embodiment of FIGS. 1 and 2, a quantity of adhesive 32 is shown on the upper surface 28 of the bottom layer 26. In some embodiments, the quantity of adhesive 32 is applied to the entire upper surface 28 or substantially the entire upper surface 28 of the bottom layer 26 and/or to the entire lower surface 24 or substantially the entire lower surface 24 of the top layer 20. However, in other embodiments, the quantity of adhesive 32 is applied only to one or more portions of the upper surface 28 of the bottom layer 26 and/or the lower surface 24 of the top layer 20.

In some embodiments, the adhesive 32 is sprayed onto the upper surface 28 of the bottom layer 26 and/or the lower surface 24 of the top layer 20 with a spray gun. In other embodiments, the adhesive 32 is instead applied to the upper surface 28 of the bottom layer 26 and/or the lower surface 24 of the top layer 20 with one or more brushes, rollers, sponges, or other applicators. In still other embodiments, the adhesive 32 is poured onto either or both surfaces 28, 24 from one or more reservoirs, and is spread with any suitable tool(s) to cover the desired areas of the surfaces 28, 24 for later bonding. In still other embodiments, an adhesive sheet is positioned on one of the surfaces 28, 24, such as an adhesive sheet on a backing, such as a layer of high-slip and/or adhesive-resistant material that is removed from one side of the adhesive sheet after an opposite side of the adhesive sheet is applied to one of the surfaces 28, 24.

In some embodiments, the adhesive 32 comprises a gel. As used herein, the term “gel” refers to a gel elastomer—a highly viscoelastic polymer gel that is flowable prior to setting, and that assumes a deformable and elastic shape when set. The inventors have discovered that a polyurethane gel can produce excellent results in some applications. For example, the adhesive 32 can be a polyurethane gel adhesive such as Voralast GE 132 produced by The Dow Chemical Company, Midland, Mich. In some embodiments, the gel adhesive 32 has a hardness of no greater than about 90 Shore OOO and no less than about 10 Shore OOO at room temperature (i.e., 21-23 Degrees Celsius). In other embodiments, a gel adhesive hardness of no greater than about 80 Shore OOO and no less than about 25 Shore OOO at room temperature can provide good performance results in a number of body support applications. In other embodiments, a gel adhesive hardness of no greater than about 70 Shore OOO and no less than about 40 Shore OOO at room temperature can provide good performance results in a number of body support applications. All such measurements are made after any necessary set time of the adhesive gel 32.

A desirable characteristic of some gels used in embodiments of the present invention is the density of such gels, as the density of such gels can correlate to the overall elastomeric properties of the gels. In some embodiments, the adhesive is a gel having a density of no less than about 100 kg/m³ and no greater than about 1500 kg/m³. In other embodiments, a gel adhesive hardness of no less than about 250 kg/m³ and no greater than about 1200 kg/m³ can provide good performance results in a number of body support applications. In other embodiments, a gel adhesive hardness of no less than about 500 kg/m³ and no greater than about 1000 kg/m³ can provide good performance results in a number of body support applications. Also, in some embodiments, the adhesive gel can have a complex viscosity of about 900 Pa·s @1 HZ shear frequency and @ 25° C. In these and other embodiments, the adhesive quality of the gel adhesive is such that after setting, the foam being bonded by the adhesive gel tears before delamination of the set adhesive gel from the foam.

In some embodiments, the gel adhesive 32 is applied at or near room temperature (i.e., between about 15 and about 20 degrees Celsius), such as in the case of polyurethane gels suitable for functioning as adhesives at room temperature. Accordingly, it may not be required to heat up the gel adhesive 32 prior to applying the gel adhesive 32 to one or more surfaces of the body support 10. However, it should be noted that various embodiments of the gel adhesive 32 can be applied within a broad range of temperatures above and below room temperature.

The gel adhesive 32 can be a surface gel adhesive in some embodiments, such that the adhesive 32 does not significantly penetrate the foam layer upon which the adhesive is applied. For example, in some embodiments, the adhesive 32 permeates about 1-2 mm into the layer(s) 20, 26. The amount of layer penetration can depend at least in part upon the type of foam used for the layer(s) 20, 26 of the body support 10. For example, a deeper penetration (i.e., greater than 2 mm) can be provided in reticulated foams, whereas little to no penetration can be provided in non-reticulated foams. In some embodiments either or both layers 20, 26 is entirely or partially enclosed in a covering material (not shown). This covering material can be different from the cover 11 described above, although the covering material can be made of any of the materials also described above in connection with the cover 11. For example, each of the layers 20, 26 can be surrounded by a respective covering material of a fine mesh, cheesecloth or other relatively thin fabric, and the like. By enclosing one or more layers in its own covering material, the layers 20, 26 can be moved and positioned with respect to one another more easily. In embodiments in which either or both layer 20, 26 has its own covering material as just described, the gel adhesive 32 can permeate the covering material to cover, and in some cases impregnate, surfaces of the layers 20, 26 as described above.

In some embodiments, a polyurethane gel adhesive 32 is used that can be considered to be a solid because the viscosity of the gel adhesive 32 is too high to measure easily (i.e. the flow rate of the polyurethane gel adhesive 32 is very slow). The polyurethane gel adhesive can be applied at or near room temperature while still remaining sticky to form the necessary bond between the top layer 20 and the bottom layer 26 of the body support 10.

The polyurethane gel adhesive 32 utilized in the illustrated embodiment of FIGS. 1 and 2 will not harden over time as other adhesives do. Such hardening can compromise the comfort of the body support in light of the fact that the softness and/or cushioning of the body support can be adversely affected by the existence of the relatively hard layer of adhesive within the body support. This adverse impact can be more significant for body supports having one or more viscoelastic foam layers.

Many conventional adhesives, such as hot melts and other water-based glues, require heating before application to a foam layer. Since such adhesives are heat-consuming (i.e. require heat-treatment to high temperatures), heating such adhesives is also energy-consuming and time-consuming. Furthermore, such adhesives must typically remain on the foam layer for a time to permit the adhesive to cure before a second foam layer can be positioned on the first foam layer and the adhesive. In contrast, by virtue of the fact that the polyurethane gel adhesive used in some embodiments of the present invention can be applied at or near room temperature to a first foam layer, the second foam layer can be immediately positioned on the first foam layer and the adhesive in some embodiments. Also, according to some embodiments of the present invention, the gel adhesive 32 can be applied at any of a variety of temperatures, such as between about 0 degrees Celsius and about 100 degrees Celsius.

In some embodiments, the gel adhesive 32 permits transfer of stress and force therethrough to one or more foam layers on either side of the gel adhesive 32. The following is a description of some examples of material testing performed on samples of the body support 10 and gel adhesive 32. Unless otherwise specified, the hardness of a material referred to herein is measured by exerting pressure from a plate against a sample of the material having length and width dimensions of 40 cm each (defining a surface area of the sample of material), and a thickness of 5 cm to a compression of 40% of an original thickness of the material at approximately room temperature (i.e., 21-23 Degrees Celsius), wherein the 40% compression is held for a set period of time following the International Organization of Standardization (ISO) 2439 hardness measuring standard.

Testing of a sample body support having two layers of viscoelastic foam stacked atop each another but not connected thereto resulted in an ILD hardness test of 61 N at 10% compression, 180 N at 25% compression, and 414 N at 40% compression. In contrast, testing of the same body support in which the two layers are connected together via a water-borne adhesive available from Alfa Adhesives, Inc. of Hawthorne, N.J. resulted in an ILD hardness test of 66.1 N at 10% compression, 198.6 N at 25% compression, and 463.2 N at 40% compression, whereas testing of a comparable body support in which the two layers are connected together via the Voralast GE 132 adhesive gel described above resulted in a significantly lower ILD hardness test of 60.5 N at 10% compression, 183.9 N at 25% compression, and 421.2 N at 40% compression. All test measurements were performed following the ISO 2349 standard (applied to the stacked foam layers, rather than to just a single layer of foam).

The inventors have discovered that the hardness difference between viscoelastic foam layers coupled by a hot-melt or water-based conventional adhesive and viscoelastic foam layers coupled by a polyurethane gel adhesive according to embodiments of the present invention can be quite significant. The hardness of the foam layer structure is significantly reduced when a polyurethane gel adhesive is used in place of a conventional water-based or hot-melt adhesive. Since hardness is reduced, force and stress are more thoroughly transferred from the first layer, through the polyurethane gel adhesive, to the second layer. The result is that the body support 10 is softer and more comfortable for a user.

A method of assembling the body support 10 includes positioning the bottom layer 26 on a support surface, applying the adhesive 32 to the upper surface 28. Following application of adhesive 32, the top layer 20 is positioned on the bottom layer 26, and the top layer 20 is coupled to the bottom layer 26. The adhesive 32 can be applied to the body support 10 by various techniques, including, but not limited to, spraying, brushing, pouring and the like. With further reference to FIGS. 1 and 2, some embodiments of the present invention teaches coupling the top layer 20 to the bottom layer 26. The top layer 20 may be further adhered to the bottom layer 26 by pressing the top layer 20 against the bottom layer 26 with one or more rollers, applying one or more weights to the body support 10, or any other similar method of coupling the top layer 20 to the bottom layer 26.

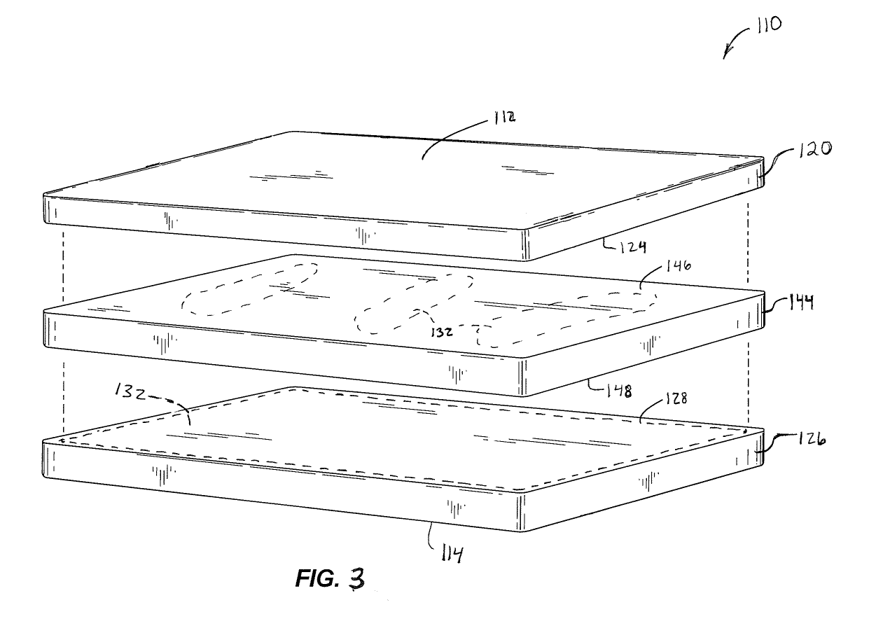

FIG. 3 illustrates another embodiment of a body support 110 according to the present invention. This embodiment employs much of the same structure and has many of the same properties as the embodiments of the body support 10 described above in connection with FIGS. 1 and 2. Accordingly, the following description focuses primarily upon the structure and features that are different than the embodiments described above in connection with FIGS. 1 and 2. Reference should be made to the description above in connection with FIGS. 1 and 2 for additional information regarding the structure and features, and possible alternatives to the structure and features of the body support illustrated in FIG. 3 and described below. Structure and features of the embodiment shown in FIG. 3 that correspond to structure and features of the embodiment of FIGS. 1 and 2 are designated hereinafter in the 100 series of reference numbers.

As mentioned above, the body support 110 can have any number of layers of material, such as multiple layers of foam material coupled together by gel adhesive. The body support 110 illustrated in FIG. 3 has three layers of material: a top layer 120 having an upper surface that is top surface 112 of the body support 110 and a lower surface 124 on an opposite side of the top layer 120. In some embodiments, the top layer 120 is a pillow top layer, and can be at least partially defined by a layer of viscoelastic or non-viscoelastic foam that is either reticulated or non-reticulated. For example, the top layer 120 of the body support 110 illustrated in FIG. 3 is a layer of viscoelastic foam, and can be quilted in some embodiments. The body support 110 illustrated in FIG. 3 also includes a bottom layer 126 having an upper surface 128 and a lower surface opposite the upper surface 128 that is bottom surface 114 of the body support 110. The body support 110 illustrated in FIG. 3 also includes a middle layer 144 positioned between the top layer 120 and the bottom layer 126. The middle layer 144 has an upper surface 146 positioned adjacent the lower surface 124 of top layer 120, and a lower surface 148 opposite the upper surface 146 and positioned adjacent the upper surface 128 of the bottom layer 126. The middle and bottom layers 144, 126 in the illustrated embodiment of FIG. 3 comprise viscoelastic foam and non-viscoelastic polyurethane foam, respectively. However, as with the top layer 120, the middle and bottom layers 144, 126 can comprise any other material desired, including without limitation any combination of visco-elastic foam, non-viscoelastic foam, latex foam, reticulated foam, non-reticulated foam, any expanded polymer (e.g., expanded ethylene vinyl acetate, polypropylene, polystyrene, or polyethylene), and the like.

The description above regarding the adhesive gel connection between the first and second layers 20, 26 in the embodiment of FIGS. 1 and 2 apply equally to the manner of connection between the top and middle layers 120, 144 and the middle and bottom layers 144, 126 illustrated in FIG. 3. Also, in some alternative embodiments of FIG. 3, the top layer 120 rests upon the middle layer 144 without being secured thereto, or the middle layer 144 rests upon the bottom layer 126 without being secured thereto.

In the illustrated embodiment of FIG. 3, gel adhesive 132 extends across substantially the entire surface area of the upper surface 128 of the bottom layer 126 and the lower surface 148 of the middle layer 144, whereas the gel adhesive 132 coupling the top and middle layers 120, 144 is located only in three areas between the top and middle layers 120, 144, it being understood that the gel adhesive 132 can be located in any other number of areas having any other locations and sizes between the top and middle layers 120, 144. The locations, shapes, and sizes of the gel adhesive areas between the top and middle layers 120, 144 and between the middle and bottom layers 144, 126 in the embodiment of FIG. 3 are illustrated by way of example only, and are not intended to limit the scope of the present invention.

A method of assembling the body support 110 illustrated in FIG. 3 can include applying gel adhesive 132 to the upper surface 128 of the bottom layer 126 and/or the lower surface 148 of the middle layer 144, positioning the middle layer 144 on the bottom layer 126 to couple the middle layer 144 to the bottom layer 126, applying gel adhesive 132 to the upper surface 146 of the middle layer 144 and/or the lower surface 124 of the top layer 120, and positioning the top layer 120 on the middle layer 144 to couple the top layer 120 to the middle layer 144, although the first two steps and the last two steps of this process can be reversed in other embodiments, or can occur substantially simultaneously. The steps of applying the gel adhesive 132 can include any of the above-described techniques for applying adhesive 132 to a body support, such as spraying, brushing, pouring and the like. Also, coupling the layers 120, 144, 126 can include pressing the respective layers (e.g., the middle layer 144 against the bottom layer 126, and/or top layer 120 against the middle layer 144) with one or more rollers, applying one or more weights to the body support 110 or to portions thereof, and/or any other suitable method of insuring sufficient contact pressure to couple the top layer 120, middle layer 144 and bottom layer 126 using the gel adhesive 132.

Various features and advantages of the invention are set forth in the following claims.

What is claimed is:

1. A body support assembly comprising:
a first layer;
a second layer, wherein at least one of the first and second layers comprises a visco-elastic foam; and
a gel adhesive bonding the first layer to the second layer.

2. A body support assembly as defined in claim 1, wherein both the first layer and the second layer comprise visco-elastic foam.

3. A body support assembly as defined in claim 1, wherein the gel adhesive has a hardness no greater than 90 Shore OOO at room temperature.

4. A body support assembly as defined in claim 1, wherein the gel adhesive has a hardness from 10 Shore OOO to 90 Shore OOO at room temperature.

5. A body support assembly as defined in claim 1, wherein the gel adhesive has a hardness from 25 Shore OOO to 80 Shore OOO at room temperature.

6. A body support assembly as defined in claim 1, wherein the gel adhesive has a hardness from 40 Shore OOO to 70 Shore OOO at room temperature.

7. A body support assembly as defined in claim 1, wherein the gel adhesive has a density from 100 kg/m³ to 1500 kg/m³.

8. A body support assembly as defined in claim 1, wherein the gel adhesive has a density from 250 kg/m³ to 1200 kg/m³.

9. A body support assembly as defined in claim 1, wherein the gel adhesive has a density from 500 kg/m³ to 1000 kg/m³.

10. A body support assembly as defined in claim 1, wherein the assembly of the first layer, the adhesive, and the second layer has a hardness that is within 10% of the hardness an unbonded assembly of the first and second layers at room temperature.

11. A body support assembly as defined in claim 1, wherein the assembly of the first layer, the adhesive, and the second layer has a hardness that is within 5% of the hardness an unbonded assembly of the first and second layers at room temperature.

12. A body support assembly as defined in claim 1, wherein the assembly of the first layer, adhesive, and the second layer has a hardness that is within 3% of the hardness an unbonded assembly of the first and second layers at room temperature.

13. A method of assembling a body support, the method comprising:
applying a gelatinous adhesive on at least one of a top surface of a first layer of foam and a bottom surface of a second layer of foam;
positioning the second layer of foam on the first layer of foam; and
coupling the second layer of foam to the first layer of foam with the gelatinous adhesive, wherein at least one of the first and second layers of foam comprises visco-elastic foam.

14. The method of claim 13, wherein applying further includes at least one of brushing, spraying and pouring.

15. The method of claim 13, wherein applying is performed by one or more of brushes, rollers and sponges.

16. The method of claim 13, further comprising applying the gelatinous adhesive on at least one of a top surface of a third layer of foam and a bottom surface of the second layer of foam;
positioning the third layer of foam on the second layer of foam; and
coupling the third layer of foam to the second layer of foam with the gelatinous adhesive.

17. The method of claim 13, wherein coupling includes pressing the first and second layers together.
